(19) United States
(12) Patent Application Publication
(10) Pub. No.: US 2004/0221872 A1
(43) Pub. Date: Nov. 11, 2004

(54) Cleaning device and method of using same

(75) Inventors: Thomas Perelli, Winchester, VA (US); Scott Juergens, Winchester, VA (US)

Correspondence Address: FOLEY AND LARDNER, SUITE 500, 3000 K STREET NW, WASHINGTON, DC, 20007, US

(73) Assignee: RUBBERMAID COMMERIAL PRODUCTS LLC

(21) Appl. No.: 10/864,434

(22) Filed: Jun. 10, 2004

Related U.S. Application Data
(62) Division of application No. 10/091,545, filed on Mar. 7, 2002.

(51) Int. Cl. A47L 13/52; B08B 1/00

(52) U.S. Cl. 134/6; 134/42; 15/257.2; 15/257.4; 15/257.5; 15/257.7; 15/257.9

(57) ABSTRACT

A cleaning device including a handle and a pan is provided. The pan has a smooth, continuous inner surface which facilitates cleaning. A ramp portion of a base of the pan has a transitional angle of inclination which facilitates pulling waste into the pan. Spacers and supports are provided to ensure that the front ramp remains in contact with a surface when a downward force is applied to the pan. A method is also provided which, using the aforementioned cleaning device, reduces the time necessary to remove a hazard on a surface.

### BACKGROUND OF THE INVENTION

1. Field of the Invention

The present invention relates to a cleaning device and, more particularly to a receptacle for receiving material that may be accompanied by a tool which may be used as a squeegee or a broom.

2. Description of the Related Art

Public areas that experience heavy pedestrian traffic are often prone to hazards, such as spilled foodstuffs and broken containers. Examples of such areas include grocery stores, hospitals, amusement parks, movie theaters, shopping malls, cafeterias, restaurants, shopping centers, stables, and stadiums.

Unattended hazards can endanger pedestrians. Sometimes pedestrians do not notice a hazard or do not take the necessary steps to avoid it. For example, slip-and-fall injuries occur in supermarkets when hazards are present in an aisle. Also, unattended hazards may be spread by a pedestrian, thus increasing the risk to others.

Unattended hazards also can create perception problems. For example, whether a customer will choose to shop in a store may depend in part on that customer's perception of the shopping environment. If unattended spills and other hazards are present, the customer may believe that the store has no commitment to cleanliness or that shopping there may be dangerous.

Hazards can remain unattended for undesirable lengths of time. A hazard usually will remain untouched until an employee removes it. For this to happen, however, an employee must first become aware of the hazard, which may take a considerable amount of time.

Even after the employee notices the hazard, it will often remain unattended while the employee obtains the needed cleaning equipment. The employee usually goes to a supply room to obtain either a dustpan and a broom (to clean solid material) or a mop, a bucket of soapy water, and a wringer (to clean fluids). The time during which the employee goes to the supply room and returns to the hazard can present an undesirably long window of vulnerability in which a passerby may contact the hazard and become injured.

The current cleaning process can create perception problems. For example, the process of wheeling a bucket full of soapy water to the hazard creates the potential for water to splash out of the bucket and create additional spills that must be addressed. In addition, from an appearance standpoint, it is disadvantageous to have passersby, who are not in the vicinity of hazard, see an employee transporting cleaning equipment, as this may give the passersby the impression that they are in an environment that is unclean and/or hazardous.

The apparatus currently used to address hazards also needs improvement. Often when using dustpans, some material, such as dust, debris, or fluid, remains on the ground in front of the dustpan and also falls back out of the pan. In addition, some dustpans provide handles for lifting the dustpan. Unfortunately, the fasteners connecting the handle to the dustpan make the dustpan difficult to clean.

For these and other reasons, a new process and apparatus are needed for timely addressing hazards in areas open to the public.

### SUMMARY OF THE INVENTION

A first aspect of the invention involves a receptacle for material. The receptacle includes a base configured to rest on a surface. The base has a containment portion for holding material and a ramp portion along which material being moved from the surface to the containment portion can be slid. In addition, the ramp portion has a top surface with a first angle of inclination at a first location that is less than a second angle of inclination at a second location located rearward of the first location; the first and second angles of inclination are measured with respect to the surface.

The receptacle may also include an indentation in a rear wall of the base which projects into an interior of the receptacle and is configured to receive at least a front portion of a user's foot. Further, an upper portion of the indentation may be configured to be a handle.

In the previously described receptacle, the angle of inclination of the top surface preferably continuously increases from the first angle to the second angle. In addition, the first angle is preferably no greater than about 20°, and the second angle is preferably no greater than about 40°. The receptacle may also include a third angle of inclination at a third location on the top surface which is less than the first angle of inclination; the third angle of inclination being disposed forward of the first location. In this instance, the first angle is preferably no greater than about 20°, the second angle is preferably no greater than about 40°, and the third angle is preferably no greater than about 15°. In addition, the ramp portion may include a blade on which the third location is positioned. Further, the blade may be detachably connected to a front part of a sloped portion of the ramp portion.

A second aspect of the invention addresses a receptacle for receiving material which includes a base and at least one spacer. The base includes a containment portion and a ramp portion. Further, the ramp portion includes a sloped portion and a flexible portion which has greater flexibility than the sloped portion and which is configured to contact a surface from which material will be removed. In addition, the flexible portion may include a detachable blade. The at least one spacer is connected to the ramp portion and is configured to maintain a rear part of the flexible portion at a predetermined height relative to the surface from which material will be removed; maintaining the predetermined height inhibits a front edge of the flexible portion from losing contact with the surface when a downward force is applied to the receptacle by a user.

The receptacle of the second aspect of the invention may also include an indentation in a rear wall of the receptacle which is configured to receive at least a front portion of a user's foot. Further, an upper portion of the indentation may be configured to be a handle. Preferably, a first of the at least one spacer is positioned at an end of the flexible portion and a second of the at least one spacer is positioned at another end of the flexible portion. In addition, each of the first and second spacers preferably has a lowest portion which is substantially coplanar with at least one pad on a rear of the base.

A third aspect of the invention involves a receptacle for material which includes a base and at least one support. The base includes a containment portion and a ramp portion. Further, the ramp portion has a sloped portion and a contact portion configured to contact a surface from which material is to be removed; the contact portion is formed of flexible material. The at least one support is connected to the ramp portion and is configured to inhibit the contact portion from losing contact with the surface from which material is to be removed, when a downward force is applied to the receptacle.

In the receptacle according to the third aspect of the invention, an indentation in a rear wall of the receptacle may be provided. The indentation is preferably configured to receive at least a front portion of a user's foot. Further, an upper portion of the indentation may be adapted to function as a handle. In addition, a first of the at least one support is preferably positioned at one end of the contact portion and a second of the at least one support is preferably positioned at an opposite end of the contact portion.

A fourth aspect of the invention addresses a receptacle for material which includes a base having a containment portion for holding material and a ramp portion along which material being moved to the containment portion can be slid; the ramp portion having a blade and a sloped portion. The receptacle also includes a first sidewall connected to a first side of the base and a second sidewall connected to a second side of the base. In addition, the blade is detachably connected to the sloped portion and is substantially recessed within the sidewalls.

In the receptacle according to the fourth aspect of the invention, substantially all of the blade is between the first and second sidewalls such that at least about 50% of the blade is between the first and second sidewalls and preferably at least about 95% of the blade is between the first and second sidewalls.

A fifth invention involves a receptacle for material which includes a base, a first sidewall connected to a first side of the base, and a second sidewall connected to a second side of the base. Further, the first and second sidewalls have substantially continuous and uninterrupted surfaces and a handle is pivotably connected to the first and second sidewalls of the receptacle.

In the receptacle according to the fifth aspect of the invention, the base and the sides are preferably integrally formed. In addition, an indentation may be provided in a rear wall of the receptacle which is configured to receive a front portion of a user's foot. The handle may include first and second engagement members which may be connected to respective outer surfaces of the first and second sidewalls. Further, the handle may also include a hanging implement by which the cleaning device is adapted to be hanged.

A sixth aspect of the invention relates to a method of reducing the time necessary to remove a hazard on a surface. This method includes the following steps: (a) storing, in an area prone to hazards, a receptacle for a hazard and a tool for moving a hazard into the receptacle; and (b) upon occurrence of a hazard, using the tool to move the hazard into the receptacle.

The aforementioned method may also include: (a) maintaining the orientation of the receptacle while using the tool to move the hazard into the receptacle by placing a front portion of a user's foot in an indentation in a rear wall of the cleaning device; and (b) pressing downward with the front portion of the user's foot thereby forcing the receptacle against the surface. In addition, the hazard may be at least one of liquid, moisture, broken glass, foodstuffs, and animal feces. Moreover, the area prone to hazards may be a grocery store, a hospital, a movie theater, an amusement park, a cafeteria, a restaurant, a stable, and a stadium. The tool used to pull the hazard into the receptacle preferably includes a shaft connected to a cleaning member which comprises a pad. Further, the pad is preferably folded rubber.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate an embodiment of the invention and together with the description, serve to explain the principles of the invention.

FIG. 1 is a frontal perspective view of a cleaning device according to an embodiment of the invention herein described;

FIG. 2 is a frontal perspective view of the cleaning device of FIG. 1 but with a blade affixed thereto;

FIG. 3 is rearward perspective view of the cleaning device shown in FIG. 1;

FIG. 4 is a perspective view of the underside of a front corner of the cleaning device shown in FIG. 1;

FIG. 5 is a cross-sectional view of a pan;

FIG. 6 is a rear view of the cleaning device shown in FIGS. 1 and 2;

FIG. 7 is a cross-sectional view of a blade of a pan where the pan is above a surface such that the blade hangs below the pan;

FIG. 8 is a cross-section view of the blade of FIG. 7 in the situation in which the pan has been lowered onto a surface;

FIG. 9 is a perspective view of a side of a yoke of the cleaning device;

FIG. 10 is a perspective view of an engagement member of a pan;

FIG. 11 is a perspective view of an engagement portion of a yoke;

FIG. 12 is a side view of the cleaning device showing a handle having a hook thereon; and

FIG. 13 is perspective view of a cleaning tool having a folded pad thereon.

### DETAILED DESCRIPTION OF THE PREFERRED EMBODIMENT

Reference will now be made in detail to a presently preferred embodiment of the invention, which is illustrated in the drawings. An effort has been made to use the same reference numbers throughout the drawings to refer to the same or like parts.

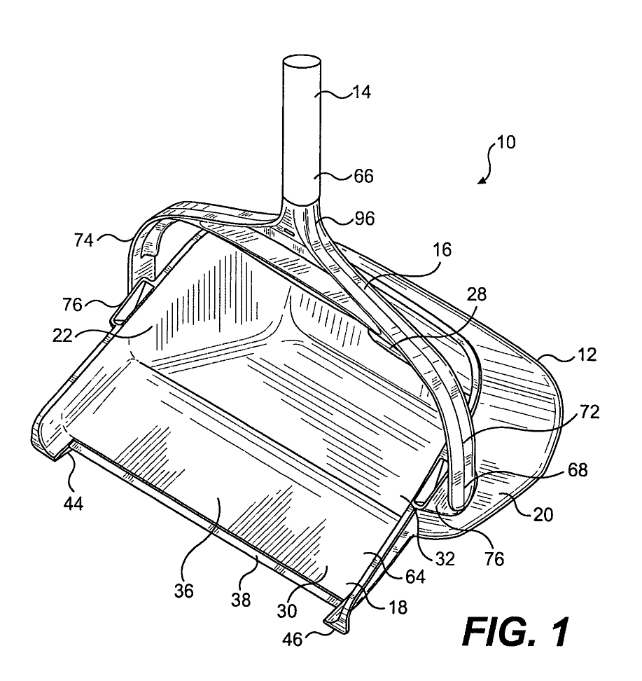

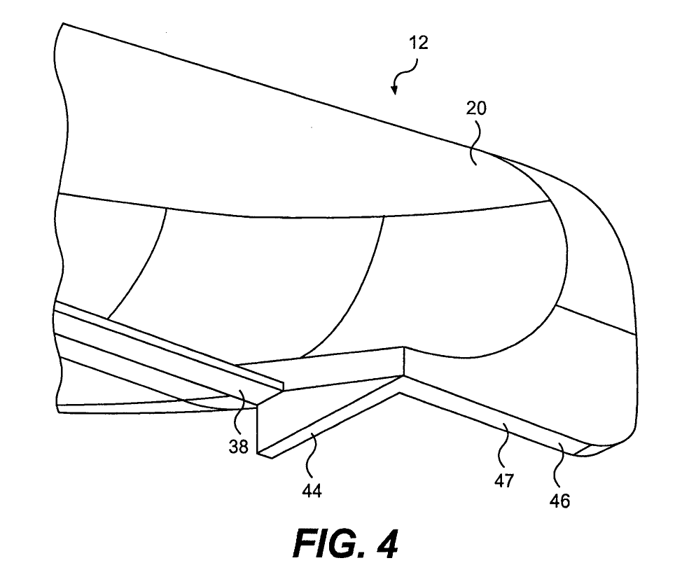

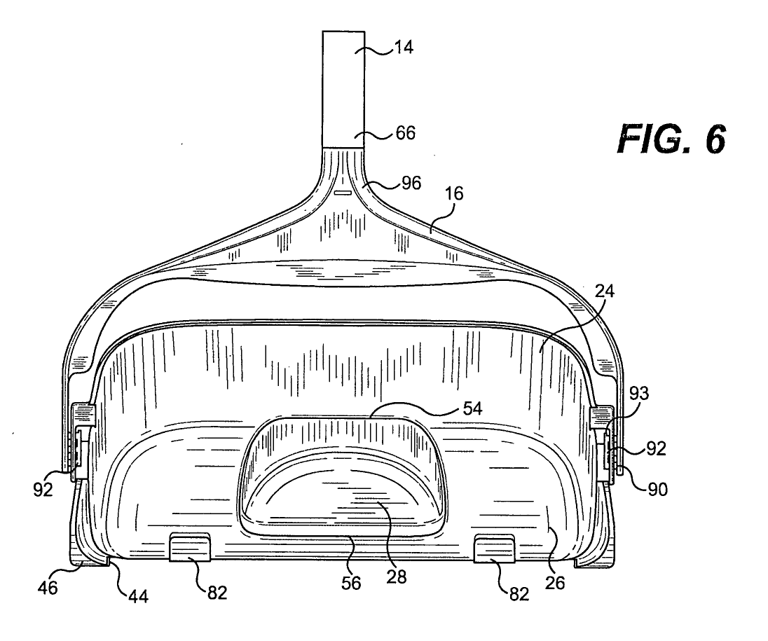

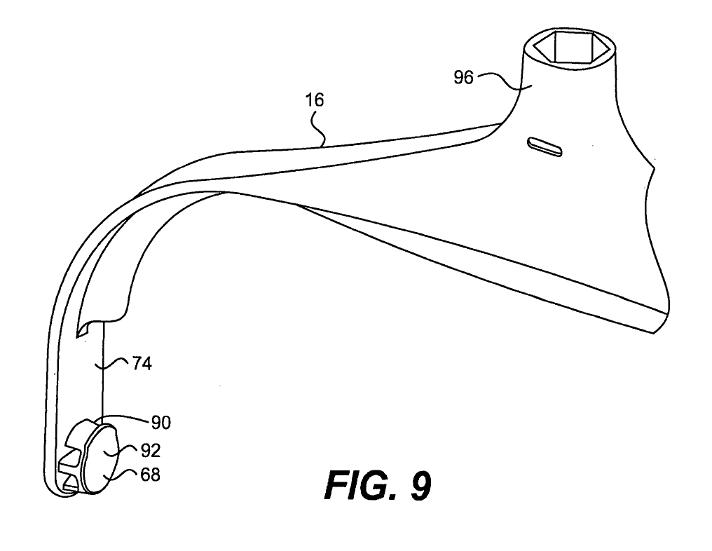

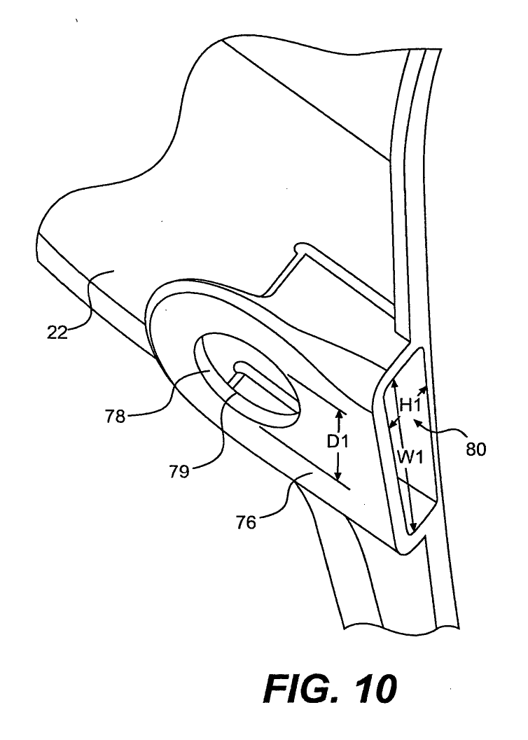

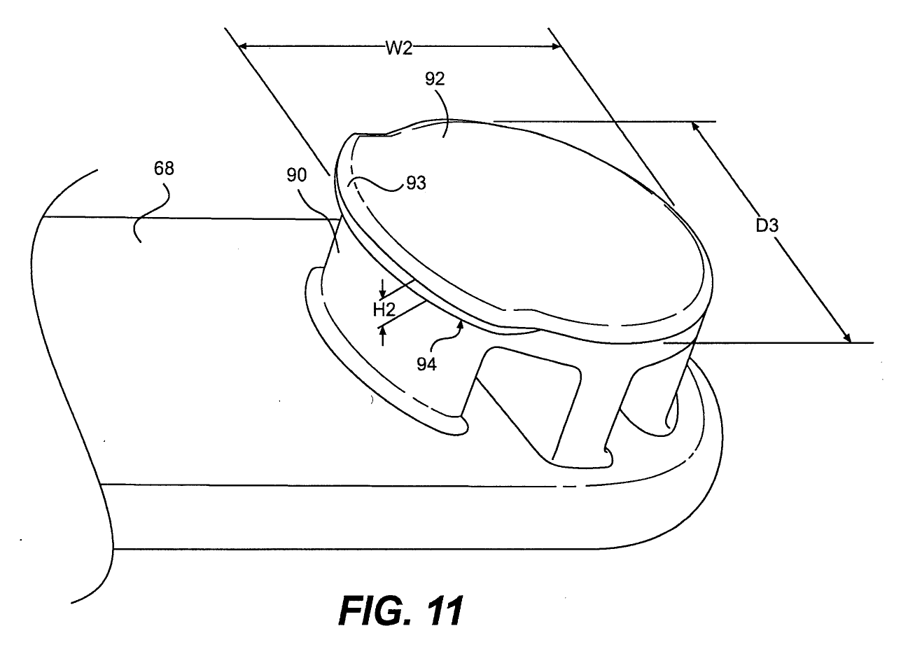

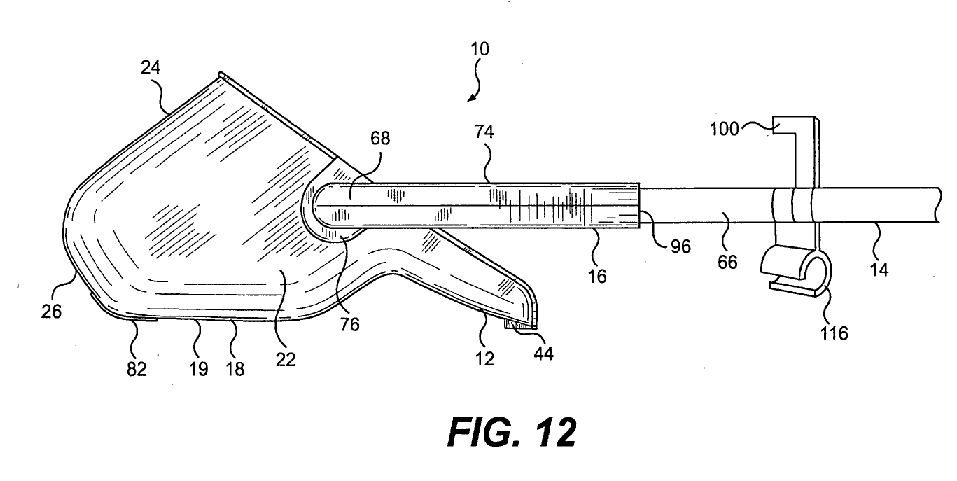

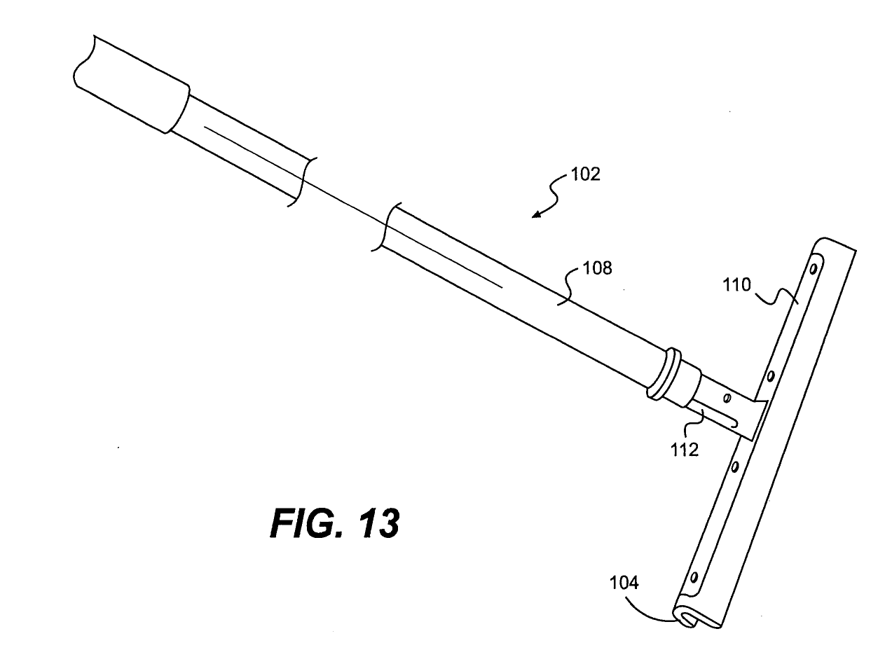

FIGS. 1 to 13 show a cleaning device 10 according to the present invention. The cleaning device 10, also called a receptacle, receives and contains material. The cleaning device 10 includes a pan 12, a handle 14, and a yoke 16 connecting the handle 14 to the pan 12. The cleaning device 10 preferably also includes a tool 102 (shown in FIG. 13) with a folded pad 104 thereon; the tool could additionally (or optionally) include a squeegee and/or broom.

The pan 12 of the cleaning device 10 is illustrated in detail in FIGS. 1 to 6. The pan 12 preferably has a base 18, right and left sidewalls 20, 22, a top wall 24, and a rear wall 26. The pan 12 is intended to be placed on a surface 48 to remove material from the surface 48.

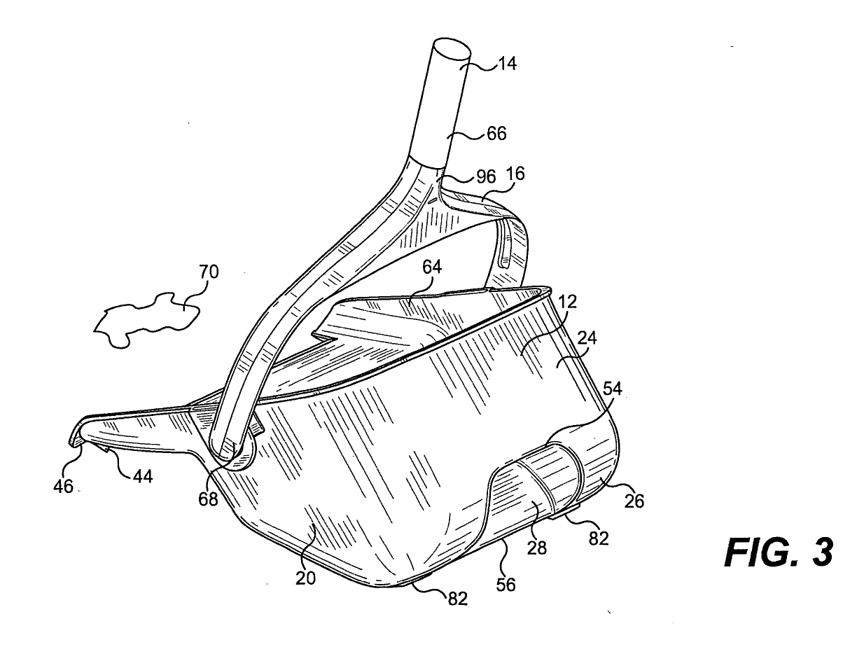

As shown in FIG. 3, the rear wall 26 of the pan 12 includes an indentation 28, which projects into an interior of the pan. The indentation 28 is sized to receive a front portion of a user's foot. An upper side 54 of the indentation 28 may be used as a handle by which a user can carry the pan 12. A bottom side 58 of the indentation 28 has an end 56 (i.e., the edge which is adjacent the rear wall 26 of the pan 12) that, in the preferred embodiment, is configured to sit slightly above a surface 48 onto which the pan 12 is placed, thereby facilitating a user's ability to slide the front portion of his foot into the indentation 28.

The bottom side 58 of the indentation 28 slopes upward and away from the end 56 and into the pan 12 in a ramp-like manner. This ramp-like design of the bottom side 58 enables a user to press the front portion of his foot on the bottom side 58. This foot pressure inhibits the pan 12 from sliding in a rearward direction when material is being moved into pan 12. Additionally, the user can provide sufficient foot pressure on the bottom side 58 to firmly press the pan 12 against the surface 48. The downward force applied by the foot may enable the user to hold the pan in a fixed position (e.g., prevent rotation of the pan) relative to a hazard 70 on the surface 48, thereby aiding in pulling the hazard 70 into the pan 12.

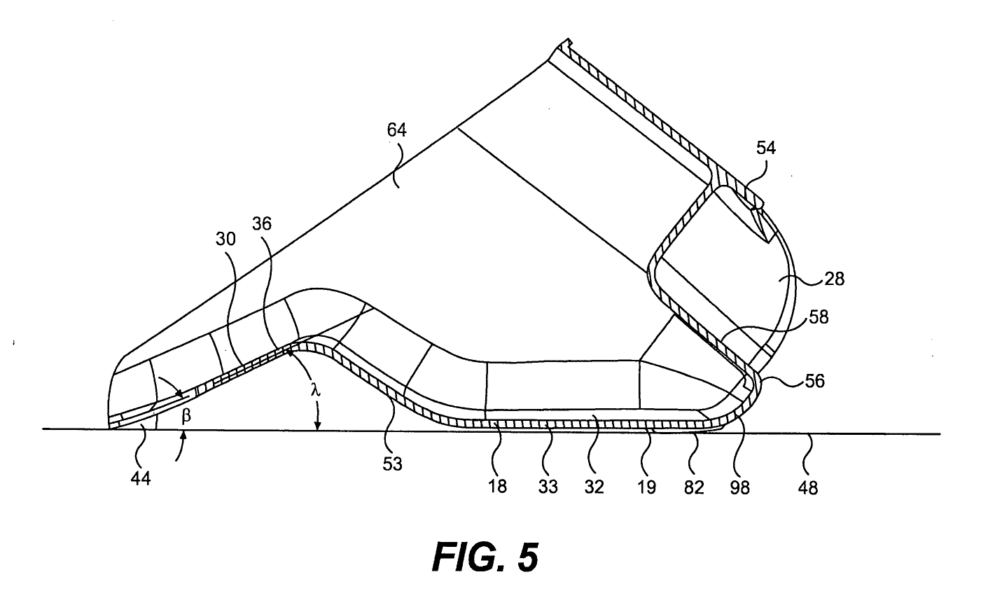

The base 18 of the pan 12 is intended to contact the surface 48. Preferably, only a portion of an underside 19 of the base 18 contacts the surface 48. In particular, in this preferred embodiment there are one or more pads 82 on the underside 19 of the base 18 which contact the surface 48. The pads 82 protect the pan 12 when it is lowered to the surface 48 and raised therefrom. Additionally, the base 18 can include spacers 44 on its underside 19. The spacers 44 preferably have respective undersides 50 that are flat, and substantially coplanar with each other and undersides of pads 82. Supports 46 also are provided on the underside 19 of the base 18. The supports 46 preferably have respective undersides 47 that are flat, and substantially coplanar with each other, undersides 50 of spacers 44, and undersides of pads 82. As shown in FIG. 5, the pads 82, spacers 44, and supports 46 (not shown in FIG. 5) contact surface 48 and keep the majority of the base 18 out of contact with surface 48 (preferably by a distance of about 1/16 of an inch).

The base 18 also includes a containment portion 32 for holding material. The containment portion 32 includes a back ramp 53 and a bottom wall 33. The volume of the containment portion 32 is preferably at least 2.0 liters and ideally at least 2.33 liters. The volume could be increased by changing the orientation of back ramp 53 (which forms a forward portion of the containment portion 32) so that it extends vertically from the top of the sloped portion 36 such that it would be perpendicular to the bottom wall 33. However, this vertical orientation would make the containment portion 32 more difficult to manufacture and more difficult to clean, as access to the region where the ramp 53 contacts the base bottom wall 33 would be cumbersome.

The base 18 also includes a ramp portion 30 for guiding material into the containment portion 32. In particular, material being moved from surface 48 to the containment portion 32 can be slid along ramp portion 30. The ramp portion 30 includes a sloped portion 36 and flexible portion 34 at the front of the sloped portion 36. Preferably the flexible portion 34 is a blade made of polyvinyl chloride (PVC).

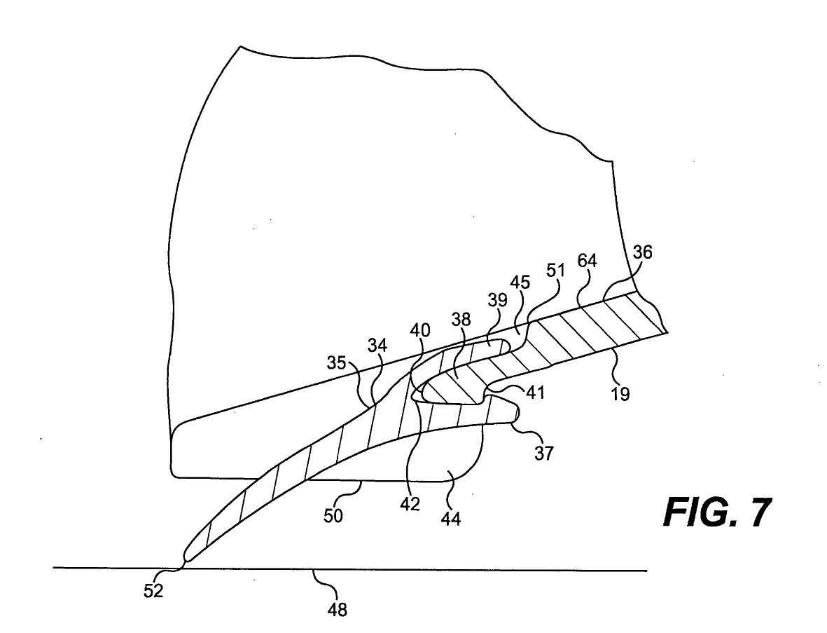

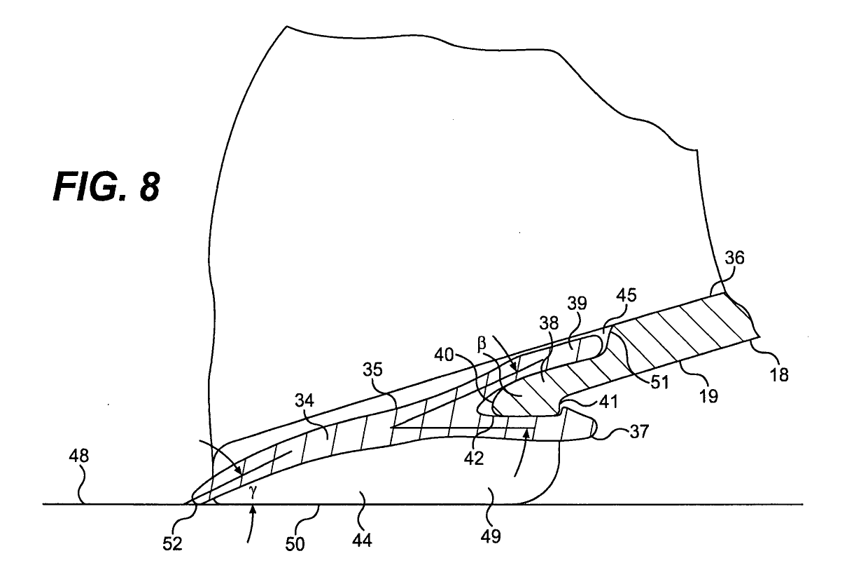

The blade 34 can be attached to the sloped portion 36 along an insert 38 that is preferably part of the sloped portion 36. As shown in FIGS. 7 and 8, a front edge 40 of the insert 38 snaps into a channel 42 formed in a back side of the blade 34 between a catch portion 37 and a top side 39 of the blade 34. As the insert 38 is pushed into the channel 42 of the blade 34, the distance between the catch portion 37 and the top side 39 of the channel 42 is increased. The blade 34 is maintained on the insert 38 when catch portion 37 snaps onto a ledge 41 formed on an underside of the insert 38. To release the blade 34, one must pull the catch portion 37 downward (i.e., away from the insert 38) and then pull the blade 34 forward (i.e., away from the insert 38) such that the catch portion 37 is freed from the ledge 41.

The blade 34 (and clearly the insert 38) is preferably recessed within sidewalls 20, 22 and toward the back of the pan 12. In other words, little or none of the blade 34 protudes forward from the sidewalls 20, 22. Thus, when the pan 12 is placed on surface 48, much of the blade 34 is between the sidewalls 20, 22, such that at least about 50%, and preferably at least about 95%, of the blade 34 is between, and does not extend forward from, the sidewalls 20, 22. The recessed nature of the blade 34 reduces the likelihood that the blade 34 will be subject, during use, to an undesirable impact on its corners or other force applied to it in the lengthwise direction. In addition, the recessed nature of the blade enhances the pan's 12 overall appearance.

The spacers 44 on base 18 cause the blade 34 to assume a preferred position when in use. The spacers 44 are preferably positioned adjacent opposite ends of the blade 34. When the pan 12 is not placed against a surface 48, the front edge 52 of the blade 34 extends below the spacers 44, as shown in FIG. 7. Preferably a small gap 45 of approximately 0.030 inches is present between the top side 39 of the blade 34 and an upper side of the sloped portion 36. As the base 18 of the pan 12 is lowered toward surface 48, the front edge 52 of the blade 34 contacts the surface 48. As the base 18 is further lowered, the blade 34 bends in a flexing region 35, due to its flexible nature, until downward movement is stopped when the undersides 50 of the spacers 44 contact the surface 48. See FIG. 8. Due to the bending of the blade 34, the top side 39 of the blade 34 slides slightly rearward thereby decreasing the width of the gap 45. The decrease in the width of the gap 45 enhances a user's ability to pull a hazard 70 up the sloped portion 36 and into the containment portion 32.

The spacers 44 also cause the blade 34 to assume a preferred orientation relative to the surface 48. The lowest portions of the spacers 44 preferably are coplanar with a lowest part of the base 18, i.e., the bottom of pads 82 in this embodiment. Thus, when the pan 12 is placed on the surface 48, the blade 34 is properly oriented with respect to the surface 48.

Moreover, the spacers 44 can inhibit curling of the blade 34. As the base 18 is moved toward surface 48, the spacers 44 prevent further downward movement of the blade 34. The spacers 44 are configured to maintain a rear part of the blade 34 at a predetermined height (preferably less than about 0.125 inches) relative to the surface 48. The spacers 44 thus define a void 49 between a rear portion of the blade 34 and the surface 48. By inhibiting the rear portion of the blade 34 from moving closer to the surface 48, the spacers 44 inhibit the front edge 52 of the blade 34 from undesirably curling away from the surface 48. Curling of the blade 34 away from the surface 48 is undesirable because it reduces the contact between the blade 34 and the surface 48 thereby inhibiting a users ability to sweep a hazard 70 into the containment portion 32 of the base 18.

It should be readily appreciated that the spacers 44 need not have any particular shape to achieve the above-mentioned results. The spacers 44, however, should be able to maintain the predetermined height.

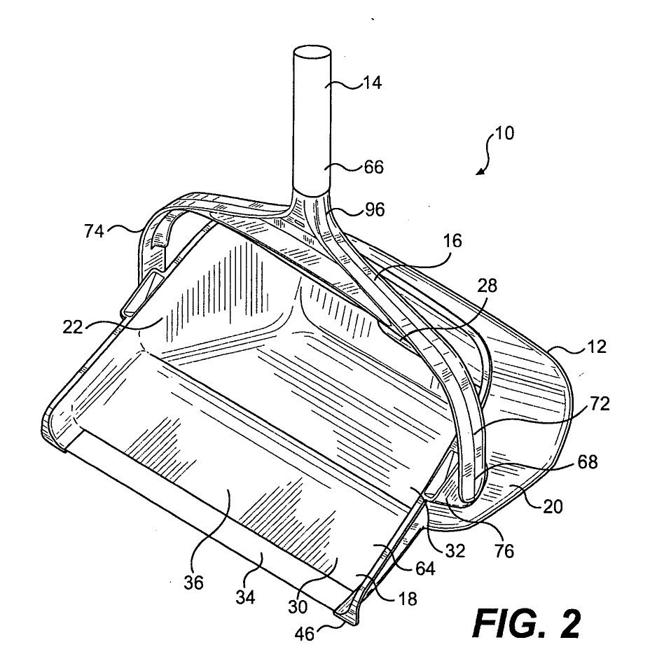

The supports 46 also facilitate contact between the blade 34 and the surface 48. The supports 46 are configured to inhibit a central portion of the blade 34 from rising off of the surface 48 when a downward force is applied to the pan 12 by a user. The supports 46 are substantially parallel to the front edge 52 of the blade 34. Although the front edge 52 of the blade 34 is depicted in FIG. 2 as being rearward of the supports 46, it is possible for the front edge 52 of the blade 34 to be even with or forward of the supports 46. If a downward force is applied to the sidewalls 20, 22, the supports 46 can inhibit the sloped portion 36 and the blade 34 from assuming a concave configuration (i.e., the supports 46 will inhibit a central portion of the blade 34 from rising off of the surface 48). Such a force may be applied to the sidewalls 20, 22 by, for example, the handle 14. It is undesirable for the blade 34 to assume a concave configuration because such a configuration reduces the contact between the blade 34 and the surface 48 thereby inhibiting a users ability to sweep a hazard 70 into the containment portion 32 of the base 18.

The angle of inclination of the ramp portion 30 is preferably different at different locations to facilitate cleaning of a hazard. Specifically, when the pan 12 rests on surface 48 it is preferable that the angle of inclination at the front edge 52 where the blade 34 meets the surface 48 be a first angle γ having a magnitude of greater than about 0° and no greater than about 15°, as measured from the surface 48; more preferably this angle γ is about 5°. From the front of the blade 34 to the front edge 51 of the sloped portion 36, it is preferable that the angle of inclination smoothly transition to a second angle β of preferably no less than about 15° and no greater than about 20°, as measured from the surface 48; this angle β is more preferably about 15°. From the front edge 51 of the sloped portion 36, it is preferable that the angle of inclination smoothly transition to a third angle λ having a magnitude of no less than about 20° and no greater than about 40°, as measured from the surface 48; this angle λ is more preferably about 24°.

By having a small first angle γ, a user's ability to pull a hazard 70 into the pan 12 with the tool 102 is enhanced because the interface between the tool 102 and the pan 12 is minimal. Further, by gradually increasing the angle of inclination to the third angle λ, the user's ability to pull the hazard 70 up the sloped portion 36 is not inhibited. Moreover, by increasing the angle of inclination, the overall length of the pan 12 can be minimized while providing a containment portion 32 having sufficient volume. By way of contrast, if the angle of inclination were to be fixed at the first angle γ and the width and rear wall 26 of the pan 12 were also fixed, to create a containment portion 32 of the same desired volume, the overall length of the ramp portion 30 and/or the pan 12 would undesirably need to be increased. Accordingly, the design facilitates pulling a hazard 70 into the pan 12 while minimizing the footprint of the base 18.

The ease by which the pan 12 can be cleaned is also facilitated by its overall design. With the exception of the gap 45 between the top side 39 of the blade 34 and the sloped portion 36, all of elements of the pan 12 preferably form a substantially continuous inner surface 64, i.e., in each location in which these elements meet, no sharp corners are present. Further, there are no holes passing from the continuous inner surface 64 to the outside of the pan 12. The substantially continuous inner surface 64 facilitates cleaning the pan 12 and, thereby, resolves the cleaning problems in the prior art. Moreover, the substantially continuous inner surface 64 inhibits germs and bacteria from accumulating in corners. Accordingly, the design is favorable for environments, such as hospitals, in which germs and bacteria must be eliminated, or at least limited.

As shown in FIGS. 1, 2, and 12, the shaft 66 of the handle 14 is connected to the yoke 16 which, in turn, is connected to the pan 12. Engagement portions 68 of the right and left sides 72, 74 of the yoke 16 rotatably sit within engagement members 76, one of which projects from each of the right and left sidewalls 20, 22 of the pan 12. Each of the engagement members 76 contains a circular opening 78 having a diameter D1 defined by a lip 79. Under each lip 79, there is a space 80 which is wider than its associated opening 78. Each of the spaces 80 has a height H1 (as measured from the bottom of the space 80 to the lip 79) and a width W1 which is larger than the diameter D1 of its associated opening 78.

The lower portions 72, 74 of the yoke 16 include projections 90 each of which has a diameter D3 which is slightly less than the diameter D1 of the openings 78 of the engagement members 76. Generally circular plates 92 extend from the projections 90. Each of the plates 92 has a detent portion 93 which projects beyond the outer circumference of its associated projection 90. As a result of the detents 93, the plates 92 have widths W2 which are greater than the diameter D1 of the openings 78 but less than the width W1 of the spaces 80. In addition, the detents 93 of the plates 92 also have a height H2 which is preferably less than the height H1 of the spaces 80. As the widths W2 of the plates 92 are greater than the diameter D3 of the projections 90, there is formed an overhang surface 94 on an underside of the detents 93 which extends around approximately 30% of the circumference of the projections 90.

To detachably connect the engagement portions 68 of the yoke 16 to the engagement members 76, the plates 92 are forced into the openings 78. As the width W2 of the plates 92 is greater than the diameter D1 of the openings 78, the detents 93 are temporarily deformed while being forced into the openings 78; the detents 93 are bent toward their respective projections 90 along the overhang surfaces 94. When the detents 93 have cleared the openings 78, they snap, due to material memory, back into substantially their non-deformed state. Moreover, as the width W2 of the plates 92 is greater than the diameter D1 of the openings 78, the plates 92 are locked into the engagement members 76, i.e., the plates 92 can not be readily pulled out of the engagement members 76 because the overhang surfaces 94 will abut the lips 79. Further, the engagement portions 68 will be able to rotate with respect to the engagement members 76 because: (a) the width W2 of the plates 92 is slightly less than the width W1 of the spaces 80; (b) the diameter D3 of the projections 90 is less than the diameter D1 of the openings 78; and (c) the height H2 of the detents 93 is less than the height Hi of the spaces 80.

An upper end 96 of the yoke 16 is fixedly connected to the shaft 66 of the handle 14. When the handle 14 is lifted which, in turn, lifts the yoke 16, the engagement portions 68 of yoke 16 rotate with respect to the pan 12. In this manner, as the handle 14 is lifted, the pan 12 rotates such that the blade 34 leaves the surface 48 while a lower edge 98 of the pads 82 (or, if no pads 82 are present, a lower edge of the rear wall 26) remains in contact with the surface 48. After the handle 14 is lifted to a point at which the blade 34 is substantially directly over the rear wall 26, a continuous lifting of the handle 14 will cause the whole of the pan 12 to lose contact with surface 48. In the situation where the blade 34 of the pan 12 is substantially directly over the rear wall 26, a hazard 70 may be carried in the pan 12.

The cleaning device 10 is sized for storage in a relatively small space either standing on the floor (such, for example, in a storage closet) or hanging on a wall. The shaft 66 of the handle 14 preferably includes a hanging implement such as, for example, a hook 100. The hook 100 will enable the cleaning device 10 to be hanged on a wall in an area prone to hazards. Such areas include grocery stores, hospitals, movie theaters, amusement parks, cafeterias, restaurants, stables, stadiums, etc. Hanging the cleaning device 10 in such areas will reduce the time necessary for a user to address a hazard occurring in such areas. In addition, the shaft 66 may also include a grip 116 which may be, for example, a conventional plastic clip having a C-shaped cross-section. By incorporating at least one grip 116 onto the shaft 66, a tool 102 (later described in detail) may be releaseably attached to the shaft 66 of the handle 14 of the cleaning device 10. Further, if the shaft 66 of the handle 14 of the cleaning device 10 includes a hanging implement (e.g., a hook 100) which may be used to hang the cleaning device 10 from a wall, the tool 102 may hanged therewith by means of the grip 116.

Various tools may be employed to move a hazard 70 into a pan 12. The preferred tool 102, shown in FIG. 13, includes a folded pad 104 which will be used to clean the surface 48. The folded pad 104 may be, for example, rubber or other solid, flexible material. Folded rubber is preferable for a number of reasons. First, because of its ability to deform, the folded pad 104 facilitates sweeping of grout lines and other instances in which a surfaces is not smooth. Second, due to its flexible nature, the folded pad 104 may be used as a squeegee to pull fluid, such as, for example, a puddle in a supermarket aisle, into a pan 12. Third, as a result of its solid, albeit deformable, nature, if the hazard 70 is solid waste such as, for example, foodstuffs on a movie theater floor, the tool 102 having the folded pad 104 thereon may used as a broom to pull the solid waste into the pan 12. In any case, the tool 102 may be used to pull the hazard 70 up the blade 34 and sloped portion 36 of the ramp portion 30 of the pan 12. Upon reaching the top of the sloped portion 36, a continued pulling of the hazard 70 with the tool 102 will pull the hazard 70 into the containment portion 32 of the pan 12. This process may be enhanced by a user putting the front portion of one of his feet into the indentation 28 in the rear wall 26 of the pan 12 and pressing downward. Pressing downward in this fashion will enable the user to maintain the orientation of the pan 12 relative to the hazard 70.

The tool 102 includes a shaft 108 which is connected to a cleaning member 110 by means of a bracket 112; the cleaning member 110 holds the folded pad 104. Although the cleaning member 110 is preferably generally straight, it may be arcuate in shape as this may enable a user to surround a hazard 70. In addition, the tool 102 could be modified to include a squeegee or a broom either in addition to, or in replacement of, the folded pad 104. As previously mentioned, by incorporating at least one grip 116 onto the shaft 66 of the cleaning device 10, the tool 102 may be releaseably attached to the shaft 66 of the handle 14 of the cleaning device 10 and hanged therewith by means of the hook 100. It should, however, be readily appreciated that either or both of the hook 100 and the clip 116 could be attached to the shaft 108 of the cleaning tool 102.

The cleaning device 10 can be used to address a hazard 70. The cleaning device 10 can be stored in an area prone to hazards such as, for example, grocery stores, hospitals, movie theaters, amusement parks, cafeterias, restaurants, stables, and stadiums. After the occurrence of a hazard 70 (e.g., liquid, moisture, broken glass, foodstuffs, and animal feces), the cleaning device 10 is removed from its storage location and the pan 12 portion of the cleaning device 10 is lowered onto the surface 48 containing the hazard 70 so that the base portion 18 thereof is adjacent the hazard 70. When the pan 12 is properly positioned, the user places the front portion of his foot into the indentation 28 and presses downward to maintain the orientation of the pan 12 with respect to the hazard 70. To pull the hazard 70 up the front ramp portion 30 and into the containment portion 32 of the pan 12, the user then uses a broom or the tool 102 previously described (i.e., the tool 102 having folded pad 104 thereon). A subsequent lifting of the handle 14 will cause the base 18 of the pan 12 to rotate (with respect to the handle 14) so that the rear wall 26 becomes substantially below the blade 34. In this position, the hazard 70 can be transported in the pan 12 to a second location at which the user can, e.g., release the hazard 70 into a refuse container (not shown).

Except where otherwise noted, the cleaning device 10 is preferably manufactured out of polypropylene using high pressure injection molding.

It will be apparent to those skilled in the art that various modifications and variations can be made to the disclosed preferred embodiments of the present invention without departing from the scope or spirit of the invention. Accordingly, it should be understood that the apparatus and method described herein are illustrative only and are not limiting upon the scope of the invention, which is indicated by the following claims.

1-28. (Cancelled)

29. A method of reducing the time necessary to remove a hazard on a surface, the method comprising the steps of:
storing, in an area prone to hazards, a receptacle for a hazard and a tool for moving a hazard into the receptacle;
upon occurrence of a hazard, using the tool to move the hazard into the receptacle.

30. The method of claim 29, further comprising the step of maintaining the orientation of the receptacle while using the tool to move the hazard into the receptacle by placing a front portion of a user's foot in an indentation in a rear wall of the cleaning device; and pressing downward with the front portion of the user's foot thereby forcing the receptacle against the surface.

31. The method of claim 29, wherein the hazard is at least one of liquid, moisture, broken glass, foodstuffs, and animal feces.

32. The method of claim 29, wherein the area prone to hazards is selected from the group consisting of a grocery store, a hospital, a movie theater, an amusement park, a cafeteria, a restaurant, a stable, and a stadium.

33. The method of claim 29, wherein the tool comprises a shaft connected to a cleaning member.

34. The method of claim 33, wherein the cleaning member comprises a pad.

35. The method of claim 34, wherein the pad is folded rubber.
